(19) United States
(12) Patent Application Publication
(10) Pub. No.: US 2011/0302079 A1
(43) Pub. Date: Dec. 8, 2011

(54) SYSTEM AND METHOD OF PROCESSING PAYMENT TRANSACTION DATA TO DETERMINE ACCOUNT CHARACTERISTICS

(76) Inventor: Brent Lee Neuhaus, Union City, CA (US)

(21) Appl. No.: 13/101,810

(22) Filed: May 5, 2011

Related U.S. Application Data
(60) Provisional application No. 61/352,557, filed on Jun. 8, 2010.

(51) Int. Cl. G06Q 40/00

(52) U.S. Cl. 705/39

(57) ABSTRACT

A system, apparatus, and method for more effectively marketing financial products and services to consumers by determining the opening date and activity level within a payment account based on data from payment transactions in which the consumer has participated. This information may be used to determine where a consumer's transaction activities place them in terms of product adoption, and hence what types of products or services the consumer might be interested in using in the future.

### CROSS REFERENCE TO RELATED APPLICATIONS

This application claims priority from U.S. Provisional Patent Application No. 61/352,557, entitled “Derived Fields For Data Collection,” filed Jun. 8, 2010, the contents of which are hereby incorporated in their entirety by reference for all purposes.

### BACKGROUND

Embodiments of the invention are directed to systems, apparatuses and methods for enabling issuers of payment devices and payment transaction processors (e.g., a payment processing organization such as Visa) to more effectively develop and market their products and services to consumers. In some embodiments, this is achieved by identifying the opening date of a payment account from data for payment transactions in which the consumer has participated. In other embodiments, this is achieved by determining whether a payment account remains active or has become inactive. More specifically, the invention is directed to a system and method that process payment transaction data (and hence use a consumer's actual spending behavior) to identify one or more of the opening date of a payment account, the activity level of transactions within that account, or the status (active or inactive, open or closed) of an account. This information may be used to segment an account owner with regards to their adoption of payment devices and related services or to study whether certain incentives, product upgrades or other actions assist an issuer or payment processor to achieve their business objectives, among other uses.

Payment devices such as debit cards or credit cards are used by millions of people worldwide to facilitate various types of commercial transactions. These transactions generate a significant amount of transaction fees and processing fees, and as a result, a very competitive market exists for the issuance and management of payment devices and accounts. This has resulted in a large variety of payment devices, payment device features, pricing strategies, levels of customer service based on account type, incentive programs for consumers, loyalty programs, and other features designed to differentiate an issuer's payment device or a payment processor's services in the marketplace and to target specific users of the payment devices and services. One area in which this is important is in the retention of consumers and the targeting of products and services to a consumer based on the amount or type of activity within the consumer's account. These products or services may include loyalty programs, rewards programs, account upgrades, payment products having specific limits or benefits, etc.

In order to most effectively determine which products or services to market to a consumer, a payment processor or issuer may benefit from having a way to determine the date at which a payment account was opened and/or an indication of the relative amount of activity (or inactivity) within a consumer's payment account. This is because the account open date and activity measure can provide insights into where an account owner (e.g., a consumer) fits on the adoption curve for the products and services offered by an issuer, payment processor or other organization. Knowledge of where an account owner fits on the adoption curve can provide guidance regarding what types of services or products the account owner may be interested in at a future date.

For example, based on one or both of these pieces of information, an issuer or payment processing organization may develop a more effective strategy for providing products or services to a consumer or account owner. This may include offers of an upgraded account or eligibility for a specific type of loyalty or rewards program. Further, by considering the account open date and activity level within the account, a payment processor may be able to determine that an account is not being used and to place an indication of that status into its account records. This indication may then be used to determine if the account owner should be contacted or if other analysis should be performed to determine if the account is worth maintaining.

However, a problem arises because although the opening date of a payment account is typically known to the issuer of the payment device used with that account, privacy concerns or regulations may prevent a payment processor or payment processing organization (such as Visa) from obtaining that information. In addition, although an issuer has access to the opening date for an account, they typically would not have access to the same types and amounts of transaction data as a payment processing organization and hence may not be able to effectively evaluate the level of activity (or lack of activity) within an account.

What is desired are a system, apparatus and method for determining the opening date of a consumer's payment account and a measure of the relative activity or inactivity occurring within the account based on data from payment transactions in which the consumer participated. Based on this information, consumer retention efforts, marketing, and product development activities can be more effectively directed at the consumer. Embodiments of the invention address these problems and other problems individually and collectively.

### SUMMARY

Embodiments of the invention are directed to a system, apparatus, and method for more effectively marketing financial products and services to consumers by determining the opening date and activity level within a payment account based on data from payment transactions in which the consumer has participated. This information may be used to determine where a consumer's transaction activities place them in terms of product adoption, and hence what types of products or services the consumer might be interested in using in the future. In some embodiments, account registration and/or payment transaction data for a consumer is processed to determine the opening date of the consumer's payment account (or in some cases, a proxy for such information). Payment transaction data may also be processed to determine a measure of the relative activity or inactivity within a consumer's account based on the timing and frequency of the consumer's payment transactions. Data regarding lost or stolen accounts may also be processed to obtain more accurate information about the opening date or activity within an account. Based on the account opening date and/or the measure of the account activity or inactivity, the consumer may be placed into one or more market segments. The market segments may correspond to specific marketing programs, consumer retention plans, offers of different products or services, etc. that are directed to consumers in that market segment.

In some embodiments, based on the results of this transaction data processing, a determination may be made regarding whether an account is open but inactive or is closed. Based on this information, an issuer or payment processor can develop a plan for contacting the account owner to market new products or services, or attempt to increase use of the account. For example, such information concerning a consumer's account can be used by an issuer, payment processor or payment processing organization to direct marketing and consumer retention efforts in a more effective manner. Such data may also be used to study or investigate how a group of account owners respond to various incentives, product upgrades, new products, or marketing plans in order to identify the most effective ways of achieving an issuer's or payment processor's business objectives. This may enable an issuer or payment processor to more effectively promote loyalty programs, incentive programs, new types of financial services, new types or features of payment devices, or other ways of increasing the activity level of an account (i.e., the number or frequency of transactions using the account) to a consumer that had discontinued or significantly reduced their use of the payment account.

In one embodiment, the invention is directed to an apparatus for processing payment account data, where the apparatus includes an electronic processor programmed to execute a set of instructions and a data storage device coupled to the electronic processor and having the set of instructions stored therein, wherein when the set of instructions are executed by the programmed electronic processor, the apparatus implements a method to:

(a) access data for a set of registered payment accounts opened by an issuer;

(b) access data obtained from payment transactions conducted using a payment account opened by the issuer;

(c) access data for payment accounts opened by the issuer that were reported as lost or stolen;

(d) process the data accessed in two or more of (a), (b), or (c) to determine an account number for each unique account found in the accessed data;

(e) associate each unique account with a corresponding set of data for the payment transactions conducted using that account;

(f) determine an opening date for each unique account; and

(g) store data for the opening date for each unique account in a data storage element coupled to the electronic processor.

In another embodiment, the invention is directed to a method of processing payment account data, where the method includes:

(a) accessing data for a set of registered payment accounts opened by an issuer;

(b) accessing data obtained from payment transactions conducted using a payment account opened by the issuer;

(c) accessing data for payment accounts opened by the issuer that were reported as lost or stolen;

(d) processing the data accessed in two or more of (a), (b), or (c) to determine an account number for each unique account found in the accessed data;

(e) associating each unique account with a corresponding set of data for the payment transactions conducted using that account;

(f) determining an opening date for each unique account; and

(g) storing data for the opening date for each unique account in a data storage element coupled to the electronic processor.

In yet another embodiment, the invention is directed to a processor-readable tangible medium storing instructions executable by a suitably programmed electronic processor to:

(a) access data for a set of registered payment accounts opened by an issuer;

(b) access data obtained from payment transactions conducted using a payment account opened by the issuer;

(c) access data for payment accounts opened by the issuer that were reported as lost or stolen;

(d) process the data accessed in two or more of (a), (b), or (c) to determine an account number for each unique account found in the accessed data;

(e) associate each unique account with a corresponding set of data for the payment transactions conducted using that account;

(f) determine an opening date for each unique account; and

(g) store data for the opening date for each unique account in a data storage element coupled to the electronic processor.

Other objects and advantages of the invention will be apparent to one of ordinary skill in the art upon review of the detailed description of the invention and the included figures.

### BRIEF DESCRIPTION OF THE DRAWINGS

FIG. 1 is a functional block diagram illustrating the primary functional elements of an exemplary system for conducting an electronic payment transaction and processing payment transaction data that may be used in implementing an embodiment of the invention;

FIG. 2 is a functional block diagram illustrating components of a payment processing network (or payment processing system) and elements that may interact with that network to enable a consumer to conduct a payment transaction, and as a result that may generate or process data used to implement a method for determining characteristics of a consumer's payment account, in accordance with some embodiments of the invention;

FIG. 3 is a block diagram illustrating data sources and data processing operations that may be used in implementing a method for determining characteristics of a consumer's payment account and using that information as part of marketing and product development programs, in accordance with some embodiments of the invention;

FIG. 4 is a flowchart illustrating a process or method for determining the opening date (or a proxy for that date) for a consumer's payment account and a measure of the relative activity within that account, and in response marketing products or services to the consumer, in accordance with some embodiments of the invention;

FIG. 5 is a table or chart illustrating how account data and transaction data may be used to generate or derive data fields that may be used to determine a strategy for marketing products or services to a consumer, in accordance with some embodiments of the invention; and

FIG. 6 is a block diagram of elements that may be present in a computing device or system configured to execute a method or process in accordance with some embodiments of the invention.

### DETAILED DESCRIPTION

Embodiments of the invention are directed to a system, apparatus, and method for more effectively marketing financial products and services to consumers by determining the opening date and activity level within a payment account based on data from payment transactions in which the consumer has participated. This information may be used to determine where a consumer's transaction activities place them in terms of product adoption, and hence what types of products or services the consumer might be interested in using in the future. In some embodiments, account registration and/or payment transaction data for a consumer is processed to determine the opening date of the consumer's payment account (or in some cases, a proxy for such information). Payment transaction data may also be processed to determine a measure of the relative activity or inactivity within a consumer's account based on the timing and frequency of the consumer's payment transactions. Data regarding lost or stolen accounts may also be processed to obtain more accurate information about the opening date or activity within an account. Based on the account opening date and/or the measure of the account activity or inactivity, the consumer may be placed into one or more market segments. The market segments may correspond to specific marketing programs, consumer retention plans, offers of different products or services, etc. that are directed to consumers in that market segment. In some embodiments, the invention may be used to identify payment accounts that are candidates for services designed to increase the level of activity within the account, such as the number of transactions or the value of transactions.

As noted, in some embodiments of the invention, payment transaction data or account registration data for a consumer's account is processed to determine a date at which a payment account was opened. The opening date may be determined directly from account registration data for certain accounts, although in some cases, it may need to be determined indirectly by using a proxy for the account opening date. This proxy may be a date at which a first transaction or other measure of account activity occurred. Payment transaction data or account registration data may also be processed to determine the last date at which the account was believed to be active. As with the account opening date, this information may also be determined indirectly by using a proxy for that date, such as the date at which the last recorded transaction occurred.

In some embodiments of the invention, based on the results of the transaction data processing, a determination may be made regarding whether an account is open but inactive or is closed. Based on this information, an issuer or payment processor can develop a plan for contacting the account owner to market new products or services, or attempt to increase use of the account. For example, such information concerning a consumer's account can be used by an issuer, payment processor or payment processing organization to direct marketing and consumer retention efforts in a more effective manner. Such data may also be used to study or investigate how a group of account owners respond to various incentives, product upgrades, new products, or marketing plans in order to identify the most effective ways of achieving an issuer's or payment processor's business objectives. This may enable an issuer or payment processor to more effectively promote loyalty programs, incentive programs, new types of financial services, new types or features of payment devices, or other ways of increasing the activity level of an account to a consumer that had discontinued or significantly reduced their use of the payment account.

In some embodiments of the invention, based on the account opening date and the last date at which an account was believed to be active, an account may be identified as one for which one or more types of services should be considered. Such services may include efforts to increase the level of transaction activity within the account, efforts to retain the account owner as a user of the account, or efforts to market financial products or services to the account owner. The spending activity within an account over time may also be used to determine the impact of specific product offers or upgrades on consumer spending and account activity, the relative spending behavior of different types of accounts, etc. Each of these examples are uses of the data that may be obtained from embodiments of the invention and represent forms of segmenting the market of payment accounts based on one or more indicators (such as account opening date, activity level, etc.). Note that in some embodiments, each market segment may instead or further be defined by a rule or heuristic that defines the characteristics of an account within that segment.

The input data used in embodiments of the invention is typically obtained as a result of a consumer being issued a payment device that is associated with a payment account, and the consumer using that device to conduct a payment transaction. The account information for the payment device and the transaction information for the transaction(s) in which the device is used are processed by a payment transaction processing system or network. An entity that is part of the payment processing system or network (such as a payment processor or payment processing organization, e.g., Visa) is responsible for processing the transaction data as part of the account management functions performed for a consumer and as part of the transaction authorization functions performed for issuers, merchants, and acquirers.

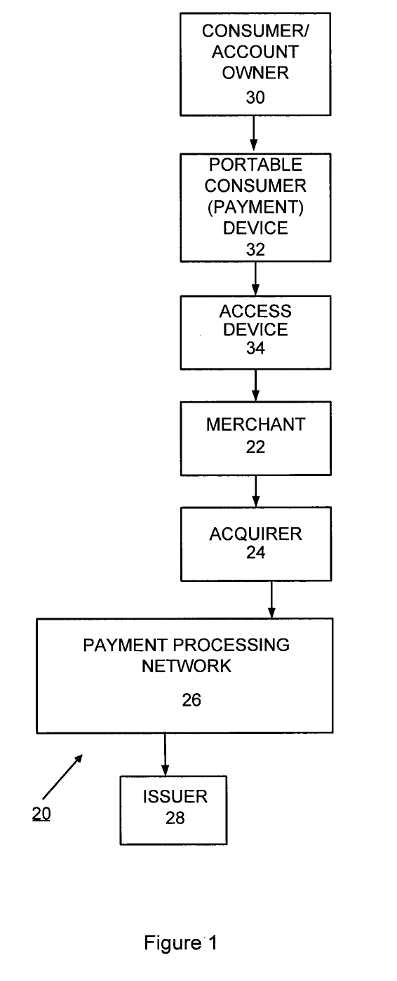

In order to provide an example of the context in which the invention may be implemented, a brief discussion of the entities involved in processing and authorizing a payment transaction and their roles in the processing of payment transaction data, will be presented. FIG. 1 is a functional block diagram illustrating the primary functional elements of an exemplary system 20 for conducting an electronic payment transaction and processing payment transaction data that may be used in implementing an embodiment of the invention. In a typical payment transaction, an account owner (e.g., an individual consumer) provides a payment account or payment device identifier to a merchant or service provider. The payment account or payment device identifier may be provided in the form of a card (e.g., a magnetic stripe card or smart card with an embedded chip) accessed by a point of sale terminal or card reader, by a contactless device embedded in a mobile device that communicates with a point of sale terminal using a wireless communications technique, or by another suitable form.

Typically, an electronic payment transaction is authorized if the consumer (who is typically the account owner) conducting the transaction is properly authenticated (i.e., their identity and their valid use of a payment account is verified) and has sufficient funds or credit to conduct the transaction. Conversely, if there are insufficient funds or credit in the account, or if the payment device is on a negative list (e.g., it is indicated as possibly having been stolen), then an electronic payment transaction may not be authorized. In the following description, an “acquirer” is typically a business entity (e.g., a commercial bank) that has a business relationship with a particular merchant. An “issuer” is typically a business entity (e.g., a bank or credit union) which issues a payment device (such as a credit card, debit card, smart card, or contactless device) to an account owner and which provides administrative and management functions for the payment account. Some entities may perform both issuer and acquirer functions.

As shown in FIG. 1, in a typical transaction, a consumer/account owner 30 wishing to purchase a good or service from a merchant provides transaction data that may be used as part of a transaction authorization process, typically by means of a portable consumer device 32 that is capable of functioning as a payment device. Account Owner 30 may utilize a device 32 such as a card having a magnetic stripe encoded with account data or other relevant data (e.g., a standard credit or debit card) to initiate the transaction. In an eCommerce (electronic commerce) transaction, the account owner may enter data into a device capable of communicating with a merchant or other element of system 20, such as a laptop or personal computer. The account owner may also initiate the transaction using data stored in and provided from a suitable form of data storage device (such as a smart card, mobile phone or PDA containing a contactless element, or a transportable memory device). As examples, a card or similar payment device may be presented to a point of sale terminal which scans or reads data from that card. Similarly, an account owner may enter payment account data into a computing device as part of an eCommerce transaction. Further, an account owner may enter payment account data into a cell phone or other device capable of wireless communication (e.g., a laptop computer or personal digital assistant (PDA)) and have that data communicated by the device to the merchant, the merchant's data processing system, or a transaction authorization network. A wireless device may also be used to initiate a payment transaction by means of communication between a contactless element embedded within the device and a merchant device reader or point of sale terminal by using a wireless communications mechanism, such as near field communications (NFC), RF, infra-red, optical, etc. Thus, in some cases an access device 34 may be used to read, scan, or otherwise interact with a payment device and thereby obtain data used in conducting a payment transaction.

The payment account data (and if needed for processing the transaction, other account owner data) is obtained from the account owner's device and provided to the merchant 22 or to the merchant's data processing system. The merchant or merchant's data processing system generates a transaction authorization request message that may include data obtained from the device as well as other data related to the transaction or to the merchant. As part of generating the authorization request message, the merchant 22 or the merchant's transaction data processing system may access a database which stores data regarding the account owner, the payment device, or the account owner's transaction history with the merchant. The merchant transaction data processing system typically communicates with a merchant acquirer 24 (e.g., a commercial bank which manages the merchant's accounts) as part of the overall transaction authorization process. The merchant's transaction data processing system and/or merchant acquirer 24 provide data to Payment Processing Network 26, which among other functions, participates in the clearance and settlement processes which are part of the transaction processing. Payment Processing Network 26 may be operated in whole or in part by a payment processing organization, such as Visa. As part of the transaction authorization process, an element of Payment Processing Network 26 may access an account database which contains information regarding the account owner's payment history, chargeback or dispute history, credit worthiness, etc. Payment Processing Network 26 communicates with issuer 28 as part of the authorization process, where issuer 28 is the entity that issued the portable consumer device to the account owner and provides administrative and management services for the consumer's payment account. Account data is typically stored in an account owner database which is accessed by issuer 28 as part of the transaction authorization and account management processes.

In standard operation, an authorization request message is created during a purchase (or proposed purchase) of a good or service at a point of sale (POS). The point of sale may be a merchant's physical location or may be a virtual point of sale such as a web-site that is part of an eCommerce transaction. In a typical transaction, the authorization request message is sent from the point of sale (e.g., the merchant or the merchant's transaction data processing system) to the merchant's acquirer 24, then to the Payment Processing Network 26, and then to the appropriate issuer 28. An authorization request message can include a request for authorization to conduct an electronic payment transaction. It may include one or more of an account owner's primary account number (PAN), the payment device expiration date, a currency code, the sale amount, a merchant transaction stamp, the acceptor city, the acceptor state/country, etc. An authorization request message may be protected using a secure encryption method (e.g., 128-bit SSL or equivalent) in order to prevent data from being compromised.

Portable consumer (payment) device 32 may be in any suitable form and may incorporate a contactless chip or other element that facilitates payment transactions. For example, suitable devices can be hand-held and compact so that they can fit into a wallet and/or pocket (e.g., pocket-sized). They may include contact or contactless smart cards, credit or debit cards (typically with a magnetic stripe and without an embedded microprocessor), keychain devices (such as the Speedpass™ which is commercially available from Exxon-Mobil Corp.), and depending upon the specific device, may incorporate a contactless element that is configured to enable the device to participate in payment transactions. Other examples of suitable payment devices include cellular phones, personal digital assistants (PDAs), pagers, payment cards, security cards, access cards, smart media, transponders, and the like, where such devices may incorporate a contactless element. Depending upon the specific design, the device may function as one or more of a debit device (e.g., a debit card), a credit device (e.g., a credit card), or a stored value device (e.g., a stored value or prepaid card).

Payment Processing Network 26 may include data processing subsystems and networks, and may be configured to implement operations used to support and deliver authorization services, exception file services, and clearing and settlement services. An exemplary payment processing network may include VisaNet. Payment processing networks such as VisaNet are able to process credit card transactions, debit card transactions, and other types of commercial transactions. VisaNet, in particular, includes a VIP system (Visa Integrated Payments system) which processes authorization requests for transactions and a Base II system which performs clearing and settlement services for transactions.

Payment Processing Network 26 may include a server computer. A server computer is typically a powerful computer or cluster of computers. For example, the server computer can be a mainframe, a minicomputer cluster, or a group of servers functioning as a unit. In one example, a server computer may be a database server coupled to a Web server. Payment Processing Network 26 may use any suitable wired or wireless network, including the Internet, to facilitate communications and data transfer between its component system elements.

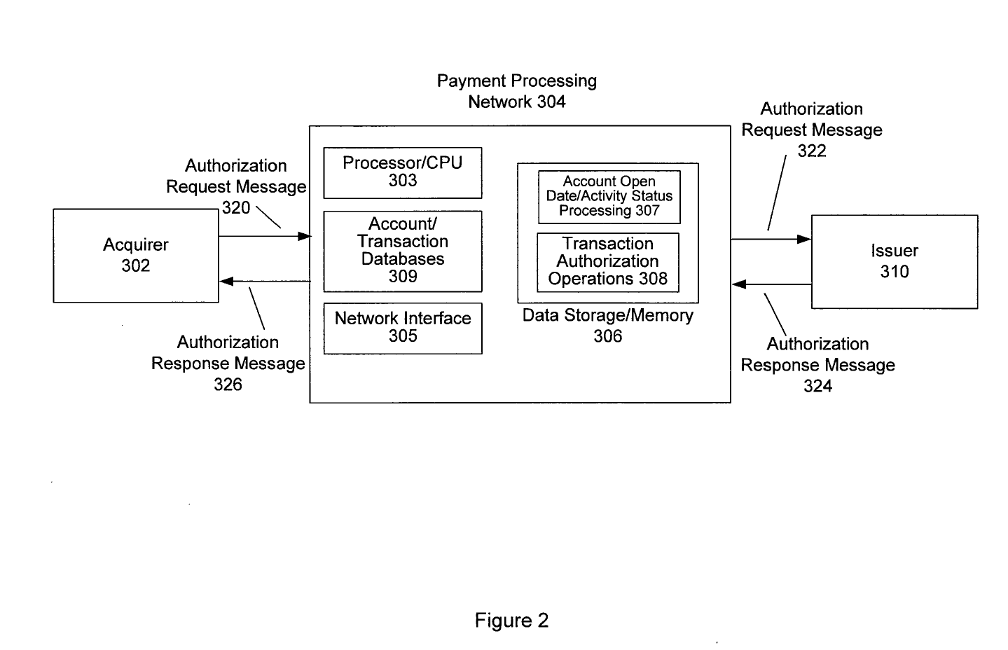

FIG. 2 is a functional block diagram illustrating components of a payment processing network (or payment processing system) and elements that may interact with that network to enable a consumer to conduct a payment transaction, and as a result that may generate or process data used to implement a method for determining characteristics of a consumer's payment account, in accordance with some embodiments of the invention. As shown in the figure, elements that interact with network 304 include an acquirer 302 which provides an authorization request message 320 for a payment transaction to payment processing network 304. Payment processing network 304 may provide a processed authorization request message 322 to issuer 310 to assist issuer 310 in deciding whether to authorize or deny a transaction. Issuer 310 provides payment processing network 304 with an authorization response message 324 containing an indication of whether the transaction has been approved or denied. Authorization response message 326 (which may be the same as message 324, or may contain other information) is provided to acquirer 302 to inform acquirer 302 (and ultimately the merchant and account owner) whether the transaction has been approved or denied.

In processing the transaction authorization messages, processing other data related to payment transactions, or processing records relating to the processing of payment transaction data by other entities in order to implement the inventive processes or methods, payment processing network 304 may utilize one or more of the components or elements depicted in FIG. 2. Such components or elements include a processor or central processing unit 303 that is programmed to execute a set of instructions, where some or all of those instructions may be stored in data storage device or memory 306. The instructions may include instructions which when executed, cause payment processing network 304 (e.g., a server or data processing apparatus that is part of network 304) to perform one or more payment transaction data processing functions or operations (as suggested by instructions or instruction set 308) and/or functions or operations used to determine or infer the opening date of a payment account and/or determine an indicator of the activity level within an account (as suggested by instructions or instruction set 307). In performing these operations, processor or central processing unit 303 may access one or more databases 309 containing transaction and account data and information. Payment processing network 304 may utilize network interface 305 to enable communication with other elements depicted in FIG. 2.

As recognized by the inventor(s), Visa and other non-bank payment processors such as payment processing systems, payment processing organizations, or payment processing networks can only capture consumer information as it relates to a transaction. For example, a payment processor may have access to the card number, merchant location, and the amount involved in a transaction, but typically will not be able to access certain information about a consumer that is normally available to the issuer of a payment device. Specifically, the date at which a consumer/cardholder opened a payment account (and hence was issued a portable consumer device by an issuer) is typically not directly available from the transaction data, but may be useful to a payment processor as part of analyzing a consumer's spending patterns and account activity, and based on that analysis, placing the account into one or more market segments for products or services.

Payment processors or payment processing organizations such as Visa (and other non-issuers) are normally unable to directly access issuer data that would provide the opening date for a payment account. In response to this situation, the inventor(s) recognized that the account opening date could be determined or inferred from an analysis of transaction data and account registration data that is available to a payment processor or payment processing organization. In this context, account registration data represents a list of open accounts, with that list being generated on a regular (e.g., monthly) basis by an issuer and provided to the payment processor or payment processing organization. Further, the accounts listed in the report are typically (though not necessarily) only a subset of the total number of payment accounts opened and managed by the issuer. For example, in some cases only premium level or upgraded accounts may be listed, with the standard entry-level accounts not listed. Thus, in some embodiments of the invention, the account registration report provided by each issuer may enable the determination of whether some of the payment accounts opened by an issuer are open as of the date of the report (although not necessarily active), but may not provide confirmation that other payment accounts (such as entry-level or non-premium accounts) are open as of the date of the report. For example, a payment processing organization such as Visa may offer multiple levels or classes of payment accounts (e.g., an entry level or traditional account, with one or more premium accounts such as a “rewards” or “signature” account that provide additional benefits for a consumer), with only the premium level accounts being listed in an issuer's account registration report.

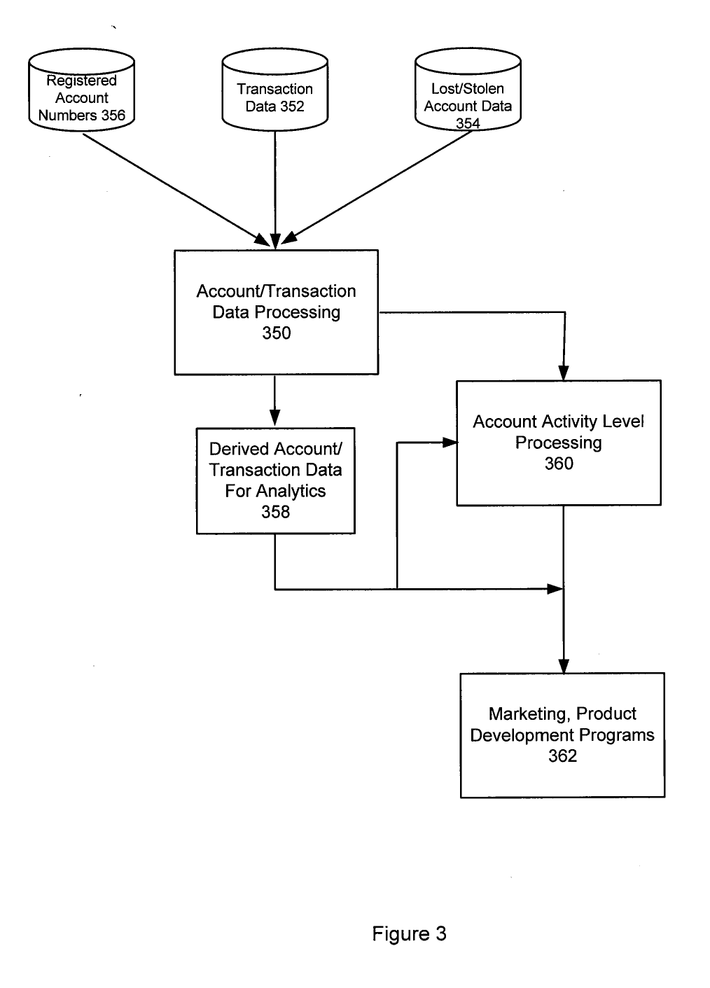

FIG. 3 is a block diagram illustrating data sources and data processing operations that may be used in implementing a method for determining characteristics of a consumer's payment account and using that information as part of marketing and product development programs, in accordance with some embodiments of the invention. As shown in the figure, in one embodiment, a data processing element processes input data to derive an opening date (or a proxy for such a date) and/or a measure of the activity within a consumer's payment account (with these operations identified as “Account/Transaction Data Processing 350” in the figure). This data processing element may be implemented as a suitably programmed processor, microprocessor, server, or other computing device capable of executing a set of instructions or software code that when executed, implements one or more of the invention's methods, operations, or processes. For example, this data processing element may be processor/CPU 303 of FIG. 2 which may be programmed with a set of executable instructions (such as those identified by “Account Open Date/Activity Status Processing 307” of FIG. 2). In some embodiments, when executed, the instructions cause the data processing element to process account registration data and/or payment transaction data to determine an opening date (or a proxy for such a date) and/or an indicator of the activity level within a consumer's payment account. Note that the payment transaction data may be derived from transactions in which one or more payment devices were used, with such payment devices being issued by one or more issuers.

The input data for Account/Transaction Data Processing 350 may include, but is not limited to, Transaction Data 352, which typically includes transaction descriptions, the date of a transaction, the account number used for a transaction, the merchant that was a party to a transaction, the zip code of the merchant, a category or other descriptive code identifying the type of merchant (such as merchant category codes), a code from which it may be determined if the transaction was a face-to-face transaction, etc. Transaction Data 352 may be processed to identify all transactions associated with a particular account number or identifier. In order to obtain a complete transaction history for a consumer, it may be necessary to determine if a consumer's account number was changed as a result of a lost or stolen account number or payment device. For example, if a consumer's payment device or account number was stolen, then they would be issued a new account number. Therefore, in order to obtain a complete history of all transactions in which the consumer participated (or in which they participated using a specific account), Lost/Stolen Account Data 354 may be accessed to check if a particular account number was reported lost or stolen, and hence replaced. If so, then the transaction data for the new account number may be accessed and appended to that of the original account number in order to ensure that all transactions in which the consumer participated are taken into consideration. Note that as will be described in greater detail, Transaction Data 352 (either alone or as appended by consideration of Lost/Stolen Account Data 354) may be processed to identify an account number corresponding to each transaction and hence be used to identify accounts and the dates at which those accounts were used to conduct a transaction.

Another source of information relating to consumer payment accounts is a database that contains account numbers for registered accounts (such as that identified by “Registered Account Numbers 356” in the figure). The data contained in Registered Account Numbers Database 356 may be generated by a regular (e.g., monthly) report provided to a payment processor or payment processing organization by one or more issuers that issue consumer payment devices associated with the payment processor or payment processing organization. The report may include a list of open payment accounts (corresponding to issued payment devices) as of the date of the report. Further, in some embodiments, the report may not list accounts corresponding to all of the issued payment devices, but instead only a subset, such as those payment devices associated with certain premium levels of service (such as rewards, signature, executive, or gold card type accounts/devices). Thus, in some cases, database 356 may not contain information about every payment device issued or account opened by the one or more issuers.

In some embodiments of the invention, the input data is processed to determine an opening date corresponding to each account. For example, the opening date may be the earliest date at which a particular account number was listed in an account registration report. However, as noted, the account registration report may not list an account number for every account opened by an issuer. For example, the account registration report provided by an issuer may only list non-entry level accounts, such as rewards or signature level accounts (e.g., for a payment processing organization such as Visa, the “Visa Traditional” accounts may not be listed, while the “Visa Traditional Rewards” and “Visa Signature” accounts may be included in the registration report). The invention overcomes this limitation by determining a proxy that may be used to infer the opening date for accounts not listed in the account registration report. In some embodiments, this proxy is obtained by processing transaction data to determine the date of the earliest transaction for an account. Thus, in some embodiments, the earliest of the date of an account's first appearance on an account registration report or first use of the account in a transaction (which as noted, is typically used for non-premium level accounts not listed in the account registration report, but may also be used for accounts listed on the registration report) is assumed to be representative of the account's opening date. Further, in some embodiments, two or more of the data sources (i.e., the registered account data, payment transaction data, or data regarding lost or stolen accounts) may be processed to obtain a reliable data record of unique account numbers and the payment transactions associated with each unique account.

In addition to determining an opening date (or a proxy for that date) for each account, embodiments of the invention also process account registration and/or transaction data to determine a measure or indicator of the activity level within an account. This data processing may include consideration of the number of transactions within a certain time period, the type of transactions, the categories of merchants involved in the transactions, the amount spent for each or a group of transactions, the average amount spent for a set of transactions, the date at which an account was last listed in an account registration report, the date of the last transaction in which an account was used, the time between an account first appearing in an account registration report and the account being used for a transaction, etc. In some embodiments, the output of the data processing may be captured as one or more elements of derived data or data fields (as indicated by “Derived Account/Transaction Data For Analytics 358” in the figure) that represent data that is stored for one or more accounts and that may be used to develop marketing or product development strategies for consumers. This derived data may include, for example, the date at which an account was first “seen” (either in an account registration report or a transaction record), the date at which an account was last “seen”, the date of the first transaction in which the account was used, the date of the last transaction in which the account was used, etc.

Further, the derived data or data fields may be used (either alone or in conjunction with other data such as account registration data or transaction data) to develop a measure of the activity level or lack of activity within an account (as represented by the element labeled “Account Activity Level Processing 360” in the figure). Based on the derived data or data fields 358 and the results of the Account Activity Level Processing 360, marketing, research, and product development programs may be proposed or evaluated (as represented by the element labeled “Marketing, Product Development Programs 362” in the figure). For example, such programs 362 may include developing a strategy for marketing new products or services to an account owner, developing new products or services for a group of account owners, evaluating the impact of an account upgrade or rewards program on an account owner or group of account owners, determining the growth rates of new accounts as opposed to existing accounts, determining trends in spending among different account types, etc. These and other possible programs or account management strategies are represented by Marketing, Product Development Programs 362.

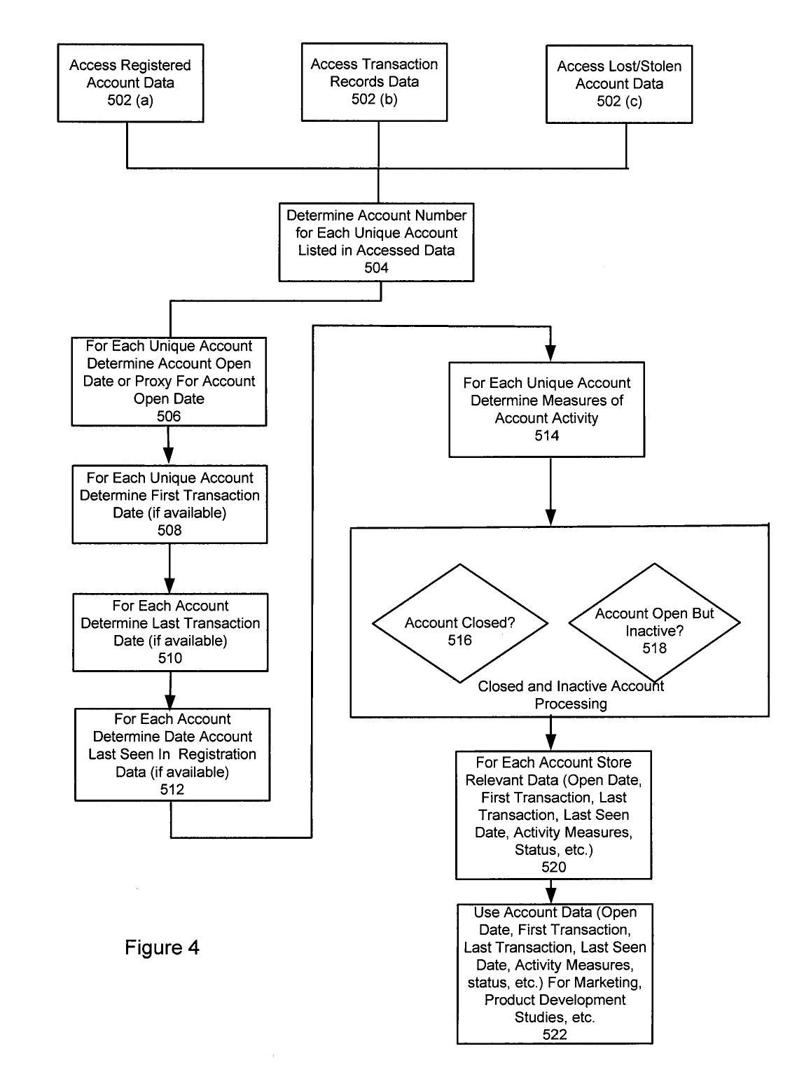

FIG. 4 is a flowchart illustrating a process or method for determining the opening date (or a proxy for that date) for a consumer's payment account and a measure of the relative activity within that account, and in response marketing products or services to the consumer, in accordance with some embodiments of the invention. The operations, method steps, and processes described with reference to FIG. 4 may be implemented by a suitably programmed computing device or data processing element. An example of such a computing device or data processing element would be a server or programmed computer that was part of payment processing network 26 of FIG. 1, such as processor/CPU 303 of FIG. 3.

As shown in FIG. 4, in some embodiments, the inventive process or method may be initiated by accessing a database, file, record, list, or other form of data storage that provides information regarding registered accounts (indicated as stage 502(a)), transaction records (indicated as stage 502(b)), and lost or stolen accounts (indicated as stage 502(c)). As mentioned, the list or report of registered accounts may be provided by an issuer or issuers on a regular basis and may include all accounts opened by an issuer, or may include only a subset of such accounts (such as those corresponding to a premium level of services). Further, as mentioned, because an account may be compromised or a payment device lost or stolen, a database of lost/stolen accounts may be accessed to obtain a more complete history of the transactions in which an account owner participated. Thus, in some embodiments, two or more of the data sources (i.e., the registered account data, payment transaction data, or data regarding lost or stolen accounts) may be processed to obtain a reliable data record of unique account numbers and the payment transactions associated with each unique account. The transaction data may include transaction descriptions, the amount of a transaction, the account number used for a transaction, the merchant that was a party to a transaction, the zip code of the merchant, a merchant category code or other descriptive code identifying the type of merchant, a code from which it may be determined if the transaction was a face-to-face transaction, etc.

Note that the inventive methods, processes, or operations may be performed on registered account data, transaction data, and lost or stolen account data for payment accounts opened or managed by more than one issuer (e.g., as part of a bulk data processing operation). However, for purposes of efficiency, optimal use of data processing resources, confidentiality, or ease of utilizing the results of the processing, it may be preferable to conduct the data processing operations on payment account associated with a specified issuer rather than a set of issuers.

Next at stage 504, an account number is determined for each unique account listed in the accessed data. In one embodiment, this may be performed as will now be described. By using the registered account data and transaction data, a list may be generated that includes each account that appears either in the registered account data or in the transaction records data. Next, the list of accounts may be cross-referenced with the list of lost or stolen accounts in order to identify which, if any, of the accounts in the list of accounts were reported as lost or stolen. For those accounts listed as lost or stolen, a replacement account number may be identified. Next, the transaction records for both the lost or stolen account number and the replacement account number (which may now appear in the registered account data or transaction records) may be merged/combined and associated with the replacement account number, and if present, the lost or stolen account number removed from the list of accounts. The result is to produce (a) a list of accounts that does not include any lost or stolen account numbers, and (b) a set of data representing the transaction records for each of the valid accounts (which may include transactions conducted using a previous account number which was reported as lost or stolen). Although the preceding description provides one process or method of identifying each unique account and associating that account with the transaction records for the account (including those associated with its previous account number in the case of a lost or stolen account), it is noted that other processes or methods are possible and are to be considered as included within the concept of the invention.

Note that although an account is listed in the registered account data, it may not be listed in the transaction records data. This may occur, for example, because an account has been opened and issued to a consumer but the consumer has not yet conducted a transaction using the account. Further, note that the transaction records data may include data for some accounts not listed in the registered account data. This may occur, for example, if the registered account data is limited to the set of premium or non-standard accounts. In such a case the transaction records data may include transactions for entry-level or non-premium accounts, where those accounts are not part of the registered account data. This may be because an issuer's agreement with a payment processor or payment processing organization only requires the issuer to identify the premium level accounts (such as rewards, signature, or awards level accounts) on the registered account reports.

Next, at stage 506, in some embodiments the inventive process or method determines an account opening date (or, as will be described, a proxy for the opening date) for each of the unique account numbers. One possible way to determine the opening date is to determine the earliest date at which an account number is found in the registered account data reports. Thus, for each account number listed in the latest registered account data report (which presumably indicates all open registered accounts), determine the earliest date at which each account appeared in any of the registered account reports. Since an account may be opened before it becomes active (i.e., used to conduct a transaction), this should provide an indication of the opening date for accounts listed in the registered account records (which as indicated may not represent all accounts opened by an issuer). However, because not all accounts opened by an issuer may be listed in the registered accounts records, embodiments of the invention also include a method or process for determining a proxy for the opening date of an account. In some embodiments, this proxy is the date at which an account first appears in the transaction records data. Thus, in some embodiments, in order to determine an opening date for an account opened by an issuer, the invention may perform the following process:

(1) for each account listed in the registered account data records, use the earliest date at which the account appears in either the registered account data records or the transaction records; and

(2) for each account listed in the transaction records data that is not listed in the registered account data records, use the date at which the account first appears in the transaction records (and hence the date at which the account was first used to conduct a transaction).

Note that other methods or processes may be used to determine the opening date for an account or a proxy for the opening date, and such other methods or processes are considered to be within the scope of the invention.

After determining the opening date or a proxy for the opening date for each account, embodiments of the invention determine the date at which each account was first used to conduct a transaction (stage 508). Note that for some accounts, this “first transaction date” will be the same as the opening date (in the case of accounts not listed in the registered account data and for which a proxy for the opening date was determined), while for other accounts the first transaction date will differ from the opening date. Further, for some opened accounts, there may not yet be a first transaction date because the account has not yet been used to conduct a transaction. This situation may occur for opened accounts listed in the registered account records that have not been used to conduct a transaction or for opened accounts not listed in the registered account records that have not yet been used to conduct a transaction (in which case neither an opening date or a first transaction date may be available).

At stage 510, embodiments of the invention determine the last date at which an account was used to conduct a transaction. Note that this data may not be available for all accounts (such as those that have not yet been used to conduct a transaction) and in some cases the first transaction date may be the same as the “last transaction date”.

At stage 512, embodiments of the invention determine the last date at which an account was present in either the account registration records or transaction records. Note that the registration information will only be available for accounts that would be listed in the registered account records, and thus for some accounts (such as entry level or non-premium accounts) a “last seen” date may not be available from this source of data.

Based on the methods or processes described, the invention may determine one or more of the following data or information for each unique account number contained in the registered account or transaction record data:

(a) the opening date (or a proxy for the opening date) for the account;

(b) a first transaction date representing the earliest date at which the account was used to conduct a transaction;

(c) a last transaction date representing the latest date at which the account was used to conduct a transaction; and

(d) where applicable, the date at which an account was “last seen” in either the registered account records or transaction records.

Next, in some embodiments of the invention, the data that has been determined and that characterizes an account (i.e., open date, last seen date, first transaction date, last transaction date) may be processed to determine one or more measures or indicia of the activity level within the account (as depicted at stage 514). The data that is processed to determine the measure(s) or indicia may include other data from the transaction records in order to provide a more complete picture of the number, type, or frequency of transactions and the amounts involved in the transactions that an account has been used to conduct.

For example, the transaction records and the determined open date, last seen date, first transaction date, and last transaction date data may be used to determine one or more of the following, either for an individual account or for a group of accounts:

the number of transactions that an account was used for within a certain time period;

the type or number of merchants that an account was used to conduct transactions with in a certain time period;

the amount spent in transactions with certain types of merchants within a certain time period;

the time period between the last transaction and the present date;

the time period between the last seen date and the present date;

the time period between the last seen date and the last transaction date;

the average time (for a set of accounts) between the account open date and the date at which the account was first used for a transaction;

changes in the type, frequency, or amount spent in a transaction over time; or

trends over time in the number of transactions, the average amount spent in each transaction, peak amounts spent, the types of merchants used for transactions, etc.

Note that the above are merely examples of the type of information that may be determined by analysis and processing of the transaction records and the determined open date, last seen date, first transaction date, and last transaction date data, and that the invention is not limited to generation and use of the types of information provided as examples.

Next, in some embodiments, the invention may use the open date, last seen date, first transaction date, last transaction date, and other processed or determined data to identify those accounts that are believed to be closed and those accounts that are believed to be open but inactive (as represented by “Closed and Inactive Account Processing” in the figure). This information may be useful to an issuer or payment processor in order to decide if the account owner should be contacted in an attempt to encourage greater use of the account, to offer a different account, or to inquire as to the reasons why an account owner discontinued use of an account.

For example, in some embodiments, in order to determine if an account is closed (stage 516), the time period between the last seen date and the present date may be evaluated. If this time period is greater than a specified amount (e.g., 3 months, 5 months, 1 year, etc.), then the account can be considered “closed”. Note that because the last seen date may only be available for a subset of the complete set of opened accounts (i.e., those contained in the registered account data records), another way of determining whether an account is likely to be closed may be needed. For example, for accounts not listed in the registered account data records, a proxy such as the date of the last transaction may be used. In such a case, if the time period between the last transaction date and the present date is greater than a specified amount (e.g., 3 months, 5 months, 1 year, etc.) and there is no outstanding balance, then the account may possibly be “closed” (or at least “inactive”, as will be discussed).

Although an account is open, it may be inactive because the account owner has not used the account to conduct a transaction for a period of time, or has conducted a limited number of transactions over a period of time. In some embodiments, in order to determine if an account should be considered “inactive” (stage 518) the “last seen” date and “last transaction” date can be considered. For example, if the time period between the last seen date and the present date is less than the specified amount that would suggest a closed account, but the time period between the last seen date and the last transaction date is greater than a specified amount (e.g., 3 months, 5 months, 1 year, etc.), then the account may be considered as being open but inactive. Note that because the last seen date may only be available for a subset of the complete set of opened accounts, another way of determining whether an account is likely to be inactive may be needed. For example, for accounts not listed in the registered account data records, a proxy such as the date of the last transaction may be used. In such a case, if the time period between the last transaction date and the present date is greater than a specified amount (e.g., 3 months, 5 months, 1 year, etc.), then the account may be considered “inactive”.

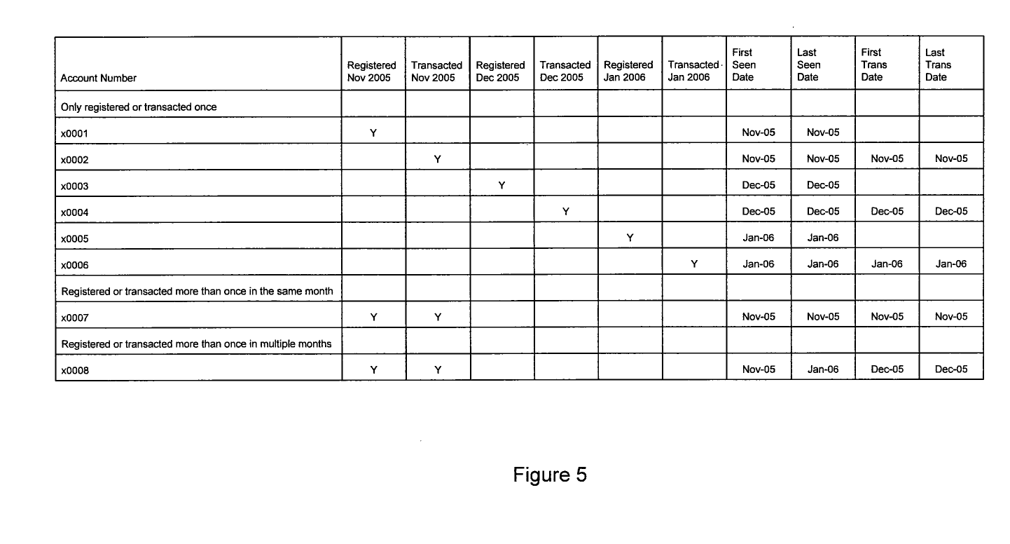

After determination of the open date, last seen date, first transaction date, and last transaction date, and any if desired, one or more indicia of the activity level within an account or the status of an account (closed, open but inactive), the determined and derived data may be stored in a database, file, record, data field, etc. (stage 520). As an example, FIG. 5 is a table or chart illustrating how account data and transaction data may be used to generate or derive data fields that may be used to determine a strategy for marketing products or services to a consumer, in accordance with some embodiments of the invention. As shown in FIG. 5, such a chart or table may indicate the date at which an account (identified as “x0001”, “x0002”, etc.) was registered, the date at which an account was used to conduct a transaction, the first seen date, the last seen date, the first transaction date, the last transaction date, etc. as a function of time or another variable of interest.

The stored data may be used by analysts, developers of products, developers of services, developers of marketing campaigns, executives interested in understanding the growth of a business across multiple segments, etc. (as represented by stage 522 in the figure). For purposes of example, the following represent potential uses of the information that may be determined or derived by use of the invention:

(1) Measure the effect of a product upgrade on cardholder spending activity. In this type of study or investigation, the first seen/last seen dates may be used to identify and eliminate new and lost/stolen accounts from the analysis, and a comparison may be made between the differences in behavior of a group that was provided with an upgraded account and a group that did not receive an upgrade. The account behavior may be characterized in terms one or more relevant characteristics, such as spending amount, the number of transactions, and the average transaction amount. In addition, changes in behavior at the merchant category code level that may result from a product upgrade can be monitored to determine whether upgraded accounts consolidate spending, or fundamentally change what they spend on. Quantifying the effects of a product upgrade may impact product upgrade strategy, product design and consulting recommendations to issuers, which ultimately relate to marketing campaigns directed at cardholders;

(2) Define and measure “organic growth”—the derived information may be used to identify and separate new accounts or upgraded accounts from existing accounts by account platform (entry level, awards, signature or other form of premium account). This type of analysis is not possible using transaction data alone, or without combining account registration and lost/stolen card data.

As an example, year over year growth rates for products are often communicated to analysts. A question that arises is whether (and to what degree) there is true growth in terms of net new accounts as opposed to cannibalization from lower grade (non-premium or entry level) platforms. The data derived from embodiments of the invention allow an identification of new and upgraded accounts. This information may be used to estimate growth rates for premium accounts net of upgraded accounts, and to quantify the effect of cannibalization. This analysis may also impact strategic decisions regarding the level of continued investment for a premium account platform.

As another example, a problem that may be investigated is to identify which account owners are trending up, down, or remaining approximately the same in terms of spending within a certain time frame, as this may imply something about a change in their socio-economic status. One approach for investigating this behavior is to select a group of account owners as subjects and to measure their annual spend over a relevant time period, for example two years. Upward or downward trend movement may be defined as “a change in the annual spend band” for the subject account (where such a band may represent a percentile range of spending or another relevant segmenting method). Such a study may identify account owners/cardholders who grew their spending in spite of economic pressures, and thus could be targeted for certain types of marketing/messaging. In addition to spending, the first seen/last seen data may be used to further segment account owners based on account age, and whether an account is new, upgraded or inactive;

(3) Investigate whether the marketing of “Reactivation” campaigns that are targeted at inactive cardholders are cost-effective and worthwhile. In this type of investigation, the first seen/last seen and transaction data may be used to:
(a) determine the time lag between account registration (i.e., opening of a premium level account) and the first transaction that the account is used to conduct;
(b) determine a workable definition for what constitutes an “inactive” account during the lifecycle of a typical account;
(c) analyze spending patterns or behavior to “predict” which accounts are most likely to become inactive based on patterns or trends that are more highly correlated with an account that becomes inactive;
(d) analyze the transaction behavior within reactivated accounts to develop insight into what account features or types of transactions might have led to the increased use of the account; or
(e) analyze the last merchant category that an account owner transacted in before the account became dormant or the first merchant category after being reactivated in order to investigate if there was a relationship between the merchants or type of transactions and the active or inactive status of the account.

Additional possible uses of the data or information obtained from embodiments of the invention relate to developing marketing campaigns for products and services that are directed at consumers who are at a specific stage of their adoption and use of a portable consumer (payment) device, where the timeframes given are for purposes of example:
1. Introduction stage (target cardholders where First Seen date <6 months from messaging date)
   a. Implement marketing messages and offers to build product awareness
      i. Encourage laggards to activate their cards (First Seen Date <3 months from messaging date and First Tran date=Null)
      ii. Encourage consumer to use (First Seen Date <6 months and First Tran date Not Null)
      iii. Communicate features and cardholder Help resources (First Seen Date <6 months)
      iv. Other offers or messaging to move cardholders out of the initial trial period towards full adoption
2. Growth Stage
   b. Build share of wallet/preference for product
      v. Keep top-of-wallet—Offers to encourage diversification of merchant spend categories, incentives to create bill-payment links, etc. (First Seen date—Messaging date >6 months, merchant spend analysis, bill-payment analysis, timing and amounts of spend)
      vi. Encourage repeated use (Last Trans date—Messaging date >3 months—encourage use of the card at least every 3 months)
3. Maturity stage
   c. Shift cardholder to better-suited products
      vii. Maximize cardholder value proposition/move to a more appropriate product for their spending patterns (segment users by First Seen dates and spend over time and develop appropriate product migration strategy)
   d. Increase Loyalty
      viii. Offers related to length of customer relationship (First Seen Date and spend behavior)
4. Decline
   e. Retention messaging when spend patterns over length of relationship meet retention criteria (Last Trans—Messaging date >6 months)
   f. Lifetime Value assessments based on length of relationship and spend patterns (Last Trans—Messaging date >6 months, ROI of LTV calculations measured against messaging costs)
5. Fraud and Risk
   g. Account age implies length of customer relationship and loyalty (First Seen Date)
   h. Combined with spending patterns could be inputs to risk models
   i. Newer accounts don't have established spending patterns, and this lack of history could be an input to fraud detection models

As noted, another potential use of the data derived from using embodiments of the invention is in the area of fraud reduction and risk assessment. This is because account age is typically used in these types of analysis and the derived data or information can provide that information. Further processing may then be used to identify potential risks.

As discussed, after embodiments of the invention have been used to determine the open date, last seen date, first transaction date, and last transaction date, and if desired, one or more indicia of the activity level within an account, the determined and derived data may be used to investigate aspects of an account that are of value to marketing and product development efforts. By determining where an account is in terms of the lifecycle or adoption curve for a product or set of products, the invention may be used to identify candidates for specific types of marketing messages, product upgrades, indicators of the desirability of developing new products or services, etc. This is because many account owners will go through a similar set of account and transaction behaviors over the lifetime of one or several types of payment accounts.

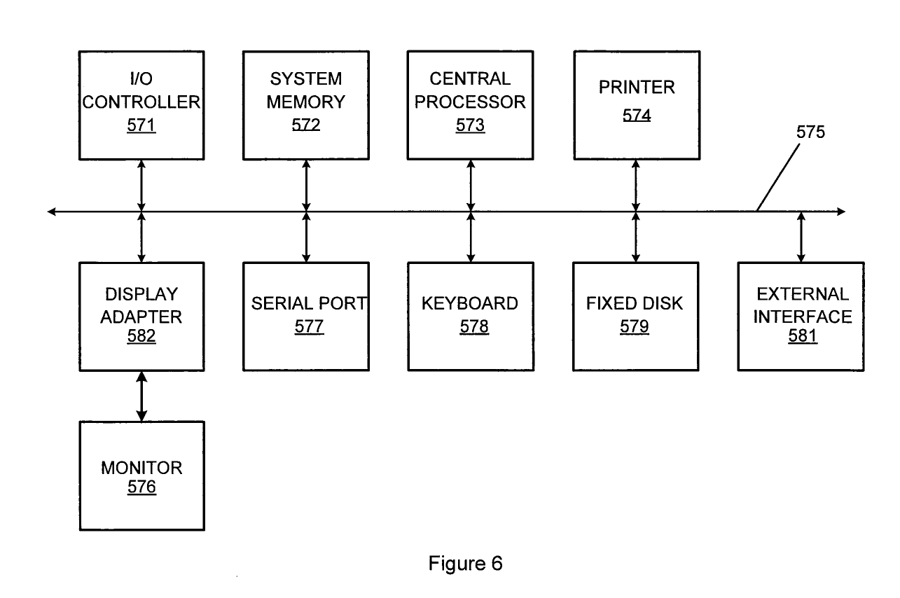

As noted, in some embodiments, the inventive methods, processes or operations may be wholly or partially implemented in the form of a set of instructions executed by a suitably programmed central processing unit (CPU) or microprocessor. The CPU or microprocessor may be incorporated in an apparatus, server or other data processing device operated by, or in communication with, a node of the transaction authorization network (such as a payment processor or element of a payment processing network 26 of FIG. 1, or processor/CPU 303 of FIG. 2). As an example, FIG. 6 is a block diagram of elements that may be present in a computing device or system configured to execute a method or process in accordance with some embodiments of the invention. The subsystems shown in FIG. 6 are interconnected via a system bus 575. Additional subsystems such as a printer 574, a keyboard 578, a fixed disk 579, a monitor 576, which is coupled to a display adapter 582, and others are shown. Peripherals and input/output (I/O) devices, which couple to an I/O controller 571, can be connected to the computing system by any number of means known in the art, such as a serial port 577. For example, the serial port 577 or an external interface 581 can be used to connect the computing device to a wide area network such as the Internet, a mouse input device, or a scanner. The interconnection via the system bus 575 allows a central processor 573 to communicate with each subsystem and to control the execution of instructions that may be stored in a system memory 572 or the fixed disk 579, as well as the exchange of information between subsystems. The system memory 572 and/or the fixed disk 579 may embody a computer readable medium.

The following are examples of pseudo-code that describes some of the operations or functions previously described with reference to FIG. 4 (specifically, portions of stages 504 to 518 of that figure). The pseudo-code is meant to be exemplary with the understanding that other algorithms, heuristics, or methods may be used to provide a similar functionality without departing from the underlying concepts of the invention.
1) Start with the Master Account List that will source its information from the Registration or Transaction data. Typically, this table will be updated on a monthly basis:

Destination Field Name

Account Number
First Seen Date (Open Date proxy)
Last Seen Date
First Transaction Date
Last Transaction Date

2) Get information from the Registered Account Database. Multiple account processing dates exist for each account, starting each month from when the account was registered and ending when the account is no longer registered. The Registration table typically has the following relevant fields and processing logic:

Destination Field Name

Account Number
First Seen from Registration
Last Seen from Registration

Example of Expected Result (at the end of the month)

| | CPD Date | | | | First Seen | Last Seen |
|---|---|---|---|---|---|---|
| Account # | (Proc Date) | Start Date | End Date | Account # | Date | Date |
| 1 | Feb. 1, 2008 | Feb. 1, 2008 | Oct. 15, 2008 | 1 | Feb. 1, 2008 | Oct. 31, 2008 |
| | Oct. 16, 2008 | Oct. 16, 2008 | Oct. 1, 2099 | | | |
| 2 | Jan. 1, 2006 | Feb. 1, 2006 | Dec. 31, 2006 | 2 | Jan. 1, 2006 | Mar. 15, 2008 |
| | Jan. 1, 2007 | Jan. 1, 2007 | Mar. 15, 2008 | | | |
| 3 | Mar. 1, 2008 | Apr. 1, 2008 | Jul. 1, 2008 | 3 | Mar. 1, 2008 | Oct. 31, 2008 |
| | May 1, 2008 | 8/12008 | Nov. 15, 2008 | | | |
| | Sep. 1, 2008 | Nov. 16, 2008 | Nov. 1, 2099 | | | |
| 4 | Jan. 1, 2006 | Feb. 1, 2006 | Dec. 31, 2006 | 4 | Jan. 1, 2006 | Oct. 15, 2008 |
| | Jan. 1, 2007 | Jan. 1, 2007 | Oct. 15, 2008 | | | |

3) Get the information from the current month Transaction database. Multiple transactions can occur throughout the month. Each transaction record has a date associated with the transaction. Typically, the Transaction table has the following relevant fields and processing logic:

| Logical Field | | Destination |
|---|---|---|
| Name | Population Logic | Field Name |
| Account Number | Direct Move | Account Number |
| Transaction | MIN(Transaction Date) for the | First Seen from |
| Date | Specified Account Number | Transaction |
| | MAX(Transaction Date) for the | Last Seen from |
| | Specified Account Number | Transaction |
| | MIN(Transaction Date) for the | First Transaction |
| | Specified Account Number | Date |
| | MAX(Transaction Date) for the | Last Transaction |
| | Specified Account Number | Date |

4) Combine information from the Registered Account, Transaction and Lost/Stolen Accounts with the Prior Month's table. Scan for Lost/Stolen account numbers and merge the old and new account activity together under the replacement account number. Updates to field values are made where the account already exists in the Master Account List, otherwise new records are inserted into the Master Account List in the case of new account numbers. Typically, the final account table has the following relevant fields and processing logic:

| Logical Field | | Destination |
|---|---|---|
| Name | Population Logic | Field Name |
| Account Number | Account Number from Registration, | Account |
| | Transaction, Lost/Stolen (Old | Number |
| | and New Account Number) or | |
| | Prior Month | |
| First Seen from | MIN(First Seen from Registration, | First |
| Registration; | First Seen from Transaction, | Seen Date |
| First Seen | First Seen Date Prior Month) | |
| from Transaction; | | |
| First Seen Date | | |
| Prior Month | | |
| Last Seen from | MAX(Last Seen from Registration, | Last |
| Registration; | Last Seen from Transaction, | Seen Date |
| Last Seen | Last Seen Date Prior Month) | |
| from Transaction, | | |
| Last Seen Date | | |
| Prior Month | | |
| First Trans from | MIN(First Trans from Transaction, | First |
| Transaction; | First Trans Date Prior Month) | Transaction |
| First Trans | | Date |
| Date Prior | | |
| Month | | |
| Last Trans from | MAX(Last Trans from Transaction, | Last |
| Transaction; | Last Trans Date Prior Month) | Transaction |
| Last Trans | | Date |
| Date Prior | | |
| Month | | |

Note that once the First Seen Date or First Transaction Date are computed, they should stay the same for the Account # over time.

It should be understood that the invention as described above can be implemented in the form of control logic using computer software in a modular or integrated manner. Based on the disclosure and teachings provided herein, a person of ordinary skill in the art will know and appreciate other ways and/or methods to implement the invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. An apparatus for processing payment account data, comprising:
an electronic processor programmed to execute a set of instructions; and
a data storage device coupled to the electronic processor and having the set of instructions stored therein, wherein when the set of instructions are executed by the programmed electronic processor, the apparatus implements a method to
(a) access data for a set of registered payment accounts opened by an issuer;
(b) access data obtained from payment transactions conducted using a payment account opened by the issuer;
(c) access data for payment accounts opened by the issuer that were reported as lost or stolen;
(d) process the data accessed in two or more of (a), (b), or (c) to determine an account number for each unique account found in the accessed data;
(e) associate each unique account with a corresponding set of data for the payment transactions conducted using that account;
(f) determine an opening date for each unique account; and
(g) store data for the opening date for each unique account in a data storage element coupled to the electronic processor.

2. The apparatus of claim 1, wherein determining an opening date for each unique account further comprises determining the earliest of the date at which the account first appears in the data for the set of registered payment accounts or the first transaction date for the account.

3. The apparatus of claim 1, wherein the method implemented by the apparatus further comprises:
determining a first transaction date for each unique account;
determining a last transaction date for each unique account;
determining a last date at which each unique account appears in the data for the set of registered payment accounts; and
storing data for the first transaction date, the last transaction date, and the last date at which each unique account appears in the data for the set of registered payment accounts in the data storage element coupled to the electronic processor.

4. The apparatus of claim 1, wherein the set of registered payment accounts comprises premium level or non-entry level payment accounts opened by the issuer.

5. The apparatus of claim 1, wherein the method implemented by the apparatus further comprises determining a measure of the activity for one or more of the unique accounts.

6. The apparatus of claim 5, wherein determining the measure of the activity for one or more of the unique accounts further comprises determining one or more of a number of transactions for which the account was used within a specified period, a type or number of merchants that the account was used to conduct transactions with in a specified time period, or the amount spent in transactions with a certain type of merchant within a specified time period.

7. The apparatus of claim 1, wherein the method implemented by the apparatus further comprises:
determining if each unique account satisfies a criteria for being considered closed; and
if the account satisfies the criteria, then storing an indication of the account being closed in a data record associated with that unique account.

8. The apparatus of claim 1, wherein the method implemented by the apparatus further comprises:
determining if each unique account satisfies a criteria for being considered open but inactive; and
if the account satisfies the criteria, then storing an indication of the account being open but inactive in a data record associated with that unique account.

9. The apparatus of claim 5, wherein the method implemented by the apparatus further comprises developing a plan to market a payment account or payment service to an owner of a payment account opened by the issuer based on the determined data and the measure of activity within the payment account.

10. The apparatus of claim 7, wherein the criteria for an account being considered closed is whether the last date at which the account appears in the data for the set of registered payment accounts is greater than a specified amount of time before the present date.

11. The apparatus of claim 8, wherein the criteria for an account being considered open but inactive is whether the last date at which the account appears in the data for the set of registered payment accounts is greater than a specified amount of time after the last transaction date for the account.

12. A method of processing payment account data, comprising:
(a) accessing data for a set of registered payment accounts opened by an issuer;
(b) accessing data obtained from payment transactions conducted using a payment account opened by the issuer;
(c) accessing data for payment accounts opened by the issuer that were reported as lost or stolen;
(d) processing the data accessed in two or more of (a), (b), or (c) to determine an account number for each unique account found in the accessed data;
(e) associating each unique account with a corresponding set of data for the payment transactions conducted using that account;
(f) determining an opening date for each unique account; and
(g) storing data for the opening date for each unique account in a data storage element coupled to the electronic processor.

13. The method of claim 12, wherein determining an opening date for each unique account further comprises determining the earliest of the date at which the account first appears in the data for the set of registered payment accounts or the first transaction date for the account.

14. The method of claim 12, further comprising:
determining a first transaction date for each unique account;
determining a last transaction date for each unique account;
determining a last date at which each unique account appears in the data for the set of registered payment accounts; and
storing data for the first transaction date, the last transaction date, and the last date at which each unique account appears in the data for the set of registered payment accounts in the data storage element coupled to the electronic processor.

15. The method of claim 12, wherein the set of registered payment accounts comprises premium level or non-entry level payment accounts opened by the issuer.

16. The method of claim 12, further comprising determining a measure of the activity for one or more of the unique accounts.

17. The method of claim 16, wherein determining the measure of the activity for one or more of the unique accounts further comprises determining one or more of a number of transactions for which the account was used within a specified period, a type or number of merchants that the account was used to conduct transactions with in a specified time period, or the amount spent in transactions with a certain type of merchant within a specified time period.

18. A processor-readable tangible medium storing instructions executable by a suitably programmed electronic processor to:
(a) access data for a set of registered payment accounts opened by an issuer;
(b) access data obtained from payment transactions conducted using a payment account opened by the issuer;
(c) access data for payment accounts opened by the issuer that were reported as lost or stolen;
(d) process the data accessed in two or more of (a), (b), or (c) to determine an account number for each unique account found in the accessed data;
(e) associate each unique account with a corresponding set of data for the payment transactions conducted using that account;
(f) determine an opening date for each unique account; and
(g) store data for the opening date for each unique account in a data storage element coupled to the electronic processor.

19. The medium of claim 18, wherein the instructions for determining an opening date for each unique account further comprise instructions to determine the earliest of the date at which the account first appears in the data for the set of registered payment accounts or the first transaction date for the account.

20. The medium of claim 18, further comprising instructions to:
determine a first transaction date for each unique account;
determine a last transaction date for each unique account;
determine a last date at which each unique account appears in the data for the set of registered payment accounts; and
store data for the first transaction date, the last transaction date, and the last date at which each unique account appears in the data for the set of registered payment accounts in the data storage element coupled to the electronic processor.
